(19) United States
(12) Patent Application Publication
(10) Pub. No.: US 2019/0337366 A1
(43) Pub. Date: Nov. 7, 2019

(54) OPENING-CLOSING BODY DRIVE DEVICE

(71) Applicant: DENSO CORPORATION, Kariya-shi, Aichi-ken (JP)

(72) Inventors: Tomohiko KAWAGUCHI, Kariya-shi (JP); Daisuke NISHIO, Kariya-shi (JP); Tomoki YAMASHITA, Kariya-shi (JP)

(73) Assignee: DENSO CORPORATION, Kariya-shi, Aichi-ken (JP)

(21) Appl. No.: 16/477,373

(22) PCT Filed: Mar. 2, 2018
(86) PCT No.: PCT/JP2018/008032

§ 371 Date: Jul. 11, 2019

(30) Foreign Application Priority Data
Mar. 2, 2017 (JP) 2017-039722
Mar. 27, 2017 (JP) 2017-061193

(51) Int. Cl. B60J 7/057; E05F 15/41

(52) U.S. Cl. CPC B60J 7/057; E05F 15/689; E05F 15/41

(57) ABSTRACT

An opening-closing body drive device includes a motor that opens and closes an opening-closing body; and a controller that controls driving of the motor. The controller recognizes an arrested position of the motor during a closing action as a reference position and performs an entrapment process in a section excluding a mask section from the reference position to a predetermined position toward an opening direction side. The controller updates the reference position when the arrested position of the motor is located toward a closing direction side of a set position, which is set in the mask section, and does not update the reference position when the arrested position of the motor is located toward an opening direction side of the set position.

### TECHNICAL FIELD

The present invention relates to an opening-closing body drive device such as a power window device or a sunroof device installed in a vehicle.

### BACKGROUND ART

Patent Document 1 discloses an example of a vehicle power window device having an anti-entrapment function that prevents foreign material from being entrapped by a window glass during a closing action. Such a power window device detects that the action of the window glass has been hampered by foreign material from the transition in the change of the rotation speed of a motor, which serves as a driving source, and performs an entrapment process that stops or reverses the motor based on the detection of the foreign material, thereby reducing the load applied to the foreign material.

### PRIOR ART DOCUMENT

### Patent Document

Patent Document 1: Japanese Laid-Open Patent Publication No. 2014-34831

### SUMMARY OF TIM INVENTION

### Problems that the Invention is to Solve

A power window device such as that described above recognizes a position (end of movable range, mechanical lock position) where the rotation of the motor is arrested during a closing action as a reference position (fully closed position). The power window device sets a section from the reference position to a predetermined position located toward an opening direction side (lower side) as a mask section, in which the entrapment process is not performed, so that the entrapment process is not performed when a window glass contacts a weather strip or the like of an upper window frame during a closing action. However, if foreign material is entrapped in the mask section, the position where the motor is arrested by the entrapment is updated as the reference position. This shifts the mask section, which is set based on the reference position, toward the opening direction side from the desired position.

Further, in a power window device such as that described above, aging changes (wear) of the weather strip raises the close end position of the window glass (i.e., arrested position of motor) relative to the weather strip. This shifts the mask section, which is set based on the reference position, from the proper position relative to the weather strip. Thus, errors tend to occur in an entrapment detection process, and the mask section will be longer than necessary.

It is an object of the present disclosure to provide an opening-closing body drive device that limits shifting of a mask section.

### Means for Solving the Problems

An opening-closing body drive device according to one aspect of the present disclosure includes a motor that opens and closes an opening-closing body; and a controller that controls driving of the motor. The controller recognizes an arrested position of the motor during a closing action as a reference position and performs an entrapment process in a section excluding a mask section from the reference position to a predetermined position toward an opening direction side. The controller updates the reference position when the arrested position of the motor is located toward a closing direction side of a set position, which is set in the mask section, and does not update the reference position when the arrested position of the motor is located toward an opening direction side of the set position.

With this structure, the controller does not update the reference position when the arrested position of the motor during the closing action is located toward the opening direction side of the set position. The set position is set in the mask section (more specifically reference position or position located toward opening direction side of reference position). This limits updating of the reference position (fully closed position) with the arrested position of the motor by entrapment when foreign material is entrapped in the mask section. As a result, shifting of the mask section by the entrapment of foreign material is limited.

In the opening-closing body drive device, the set position is set toward the opening direction side of the reference position.

With this structure, by setting the set position taking into consideration changes in the arrested position of the motor caused by environmental factors such as the temperature or the battery voltage, the reference position can be updated when the arrested position of the motor is changed by environmental factors toward the opening direction side of the reference position. This updates the reference position in a further preferable manner.

In the opening-closing body drive device, the set position is set at a position that is the same as the reference position.

With this structure, the controller does not update the reference position when the arrested position of the motor during the closing action is located toward the opening direction side of the referee-ice position. This further ensures that updating of the reference position is prevented when foreign material is entrapped in the mask section. As a result, shifting of the mask section that would be caused by the entrapment of foreign material is prevented in a further ensured manner.

In the opening-closing body drive device, the controller performs a soft stop process that stops supplying power to the motor before rotation of the motor is arrested during the closing action. When having performed the soft stop process an N number of times after updating the reference position, the controller does not perform the soft stop process in a next closing action.

With this structure, the motor is not arrested by the soft stop process unless foreign material is entrapped. Thus, the reference position is not updated until the soft stop process is performed an N number of times after updating the reference position. Thus, the controller, which performs such a process, determines whether to update the reference position based on the set position and further effectively limits shifting of reference position and the mask section.

An opening-closing body drive device according to another aspect of the present disclosure includes a motor that opens and closes an opening-closing body; and a controller that controls driving of the motor. When rotation of the motor is arrested during a closing action, the controller recognizes an arrested position as a reference position and performs an entrapment detection process in a section excluding a mask section having a predetermined length from the reference position toward an opening direction side. The controller stores an initial reference position that is the reference position in initial setting. When rotation of the motor is arrested during a closing action, the controller corrects the length of the mask section to offset a difference of the arrested position and the initial reference position.

With this structure, the controller closes the opening-closing body when initial setting is performed during, for example, an assembling stage in a factory and stores an arrested position of the motor during the closing action as an initial reference position. When rotation of the motor is arrested during a closing action after the initial setting, the controller updates the reference position with the arrested position and corrects the length of the mask section based on the reference position to offset a difference of the arrested position (updated reference position) and the initial reference position. This maintains a constant initiating position of the mask section relative to the weather strip regardless of changes in the reference position. As a result, shifting of the mask section relative to the weather strip is limited.

In the opening-closing body drive, the controller performs a soft stop process that stops supplying power to the motor before rotation of the motor is arrested during a closing action. When having performed the soft stop process an N number of times after updating the reference position, the controller does not perform the soft stop process in a next closing action.

With this structure, the soft stop process reduces situations in which the motor is stopped by rotational arrest of the motor. Thus, the reference position is less likely to be updated until the soft stop process is performed an N number of times after the reference position is updated. Thus, the controller, which performs such a process, performs the correction process of the length of the mask section. This further effectively limits shifting of the mask section.

### BRIEF DESCRIPTION OF THE DRAWINGS

FIG. 1 is a schematic diagram of the configuration of a power window device according to a first embodiment of the present disclosure.

FIG. 2 is a schematic diagram illustrating driving control of a window glass shown in FIG. 1.

FIG. 3 is a diagram illustrating a soft stop process in the first embodiment.

FIG. 4 is a flowchart illustrating an update determination process of a reference position in the first embodiment.

FIG. 5 is a flowchart illustrating an update determination process of a reference position in a modification of the first embodiment.

FIG. 6 is a diagram illustrating a correction process of a controller in a second embodiment of the present disclosure.

### MODES FOR CARRYING OUT THE INVENTION

A first embodiment of a power window device serving as an opening-closing body drive device will now be described.

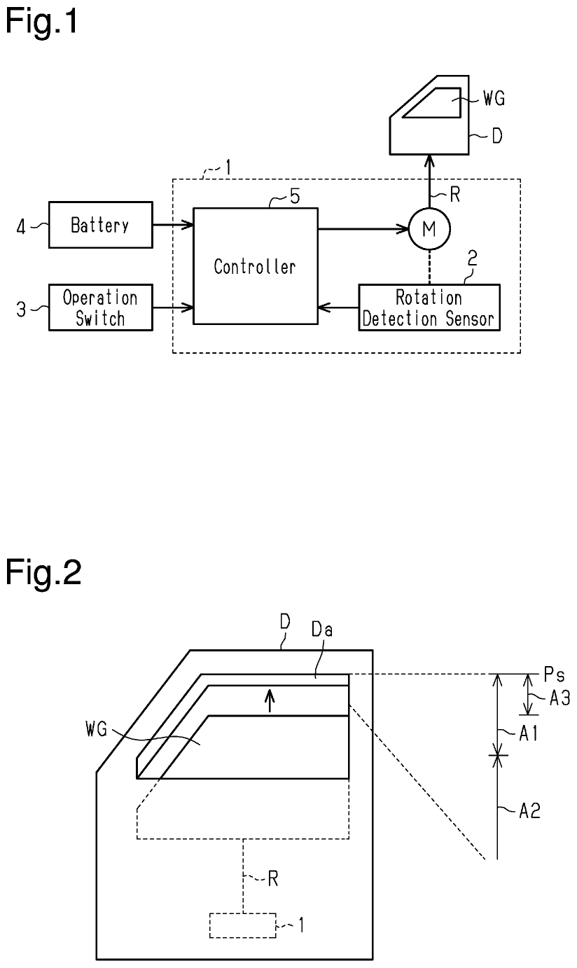

As shown in FIG. 1, a vehicle door D includes a vertically movable window glass WG serving as an opening-closing body. The window glass WG is drive-connected to a motor M of a power window device 1 by a wire-type or X-arm type regulator R.

The power window device 1 includes a rotation detection sensor 2, such as a Hall IC that detects rotation of the motor M, and a controller 5 that supplies power from a battery 4 to the motor M based on a signal from the rotation detection sensor 2 and a signal from an operation switch 3. The rotation detection sensor 2 outputs a pulse signal corresponding to the rotation of the motor M to the controller 5. The controller 5 determines the position and speed of the window glass WG and performs various types of control based on the input pulse signal in order to drive-control the motor M.

Specifically, when the operation switch 3 on the vehicle door D is operated, the controller 5 drive-controls the motor M to open or close (vertically move) the window glass WG in accordance with the operation.

The controller 5 determines whether foreign material has been entrapped by the window glass WG during a closing action based on driving information (rotation speed, current value, etc.) of the motor M. When entrapment occurs, the controller 5 performs an entrapment process that drive-controls the motor M to stop or reverse movement of the window glass WG.

During a closing action (upward movement), when the window glass WG reaches the fully closed position (close end position, mechanical lock position of movable range end) and rotation of the motor M is arrested, the controller 5 detects a lock current resulting from the arrest and stops supplying power to the motor M (lock stop process).

As shown in FIG. 2, when rotation of the motor M is arrested during a closing action and the controller 5 detects the lock current, the controller 5 recognizes the position where the rotation of the motor M was arrested (position where lock current was detected) as reference position Ps (fully closed position).Positional information on the window glass WG recognized by the controller 5 is obtained by adding a count number (pulse edge number), which is based on a pulse signal from the rotation detection sensor 2, to reference position Ps as the window glass WG moves toward the opening direction side.

The controller 5 sets a section from reference position Ps to a predetermined position in the opening direction side (lower side) (section from reference position Ps to position corresponding to predetermined number of pulse edges in opening direction side) as mask section A1 in which the entrapment process is not performed. The length of mask section A1 is constant even if reference position Ps is moved. The lower end position of mask section A1 is set to be located downward several millimeters from the lower open side end of a weather strip Da of an upper window frame even if reference position Ps moves. Reference position Ps may be changed by a change in temperature or battery voltage, aging deterioration of the regulator R or the weather strip Da, or the like. The controller 5 performs the entrapment process in a section (entrapment process section A2) outside mask section A1.

The controller 5 also performs a soft stop process that stops supplying power to the motor M before rotation of the motor M is arrested (before lock current is detected) when the window glass WG approaches reference position Ps during a closing action.

Specifically, in the soft stop process, the controller 5 sets a section from reference position Ps to a predetermined position in the opening direction side (lower side) as soft stop section A3. The length of soft stop section A3 is constant even if reference position Ps is changed. The length of soft stop section A3 is set to be less than the length of mask section A1. The upper end positions of soft stop section A3 and mask section A1 are, the same as reference position Ps. Thus, the lower end position of soft stop section A3 is set to be higher (in closing direction side) than the lower end position of mask section A1,

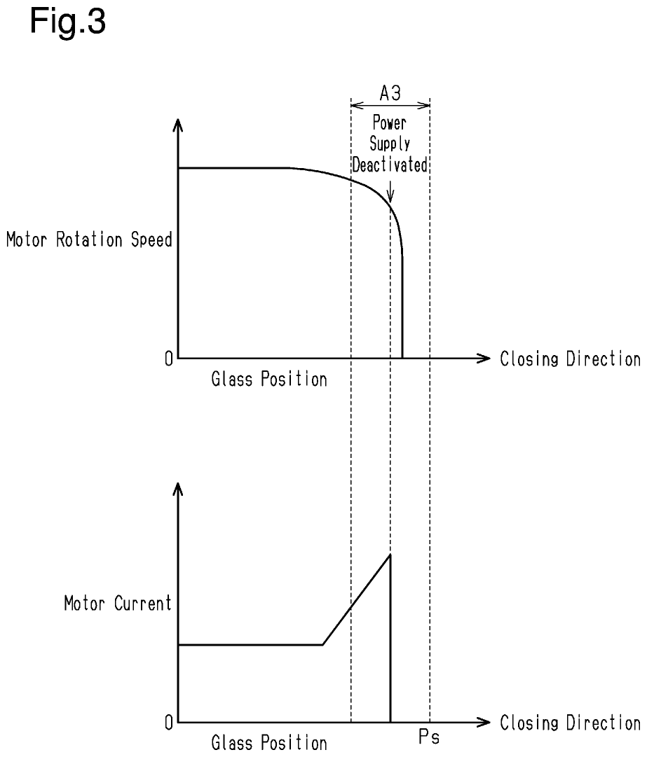

As shown in FIG. 3, in soft stop section A3, the controller 5 stops supplying power to the motor M based on a change in the rotation speed of the motor M. Since the resistance produced as the window glass WG slides in contact with the weather strip Da of the upper window frame reduces the speed of the motor M and thereby stops the supply of power to the motor M, the supply of power to the motor M is stopped before the window glass WG reaches the movable range end and the rotation of the motor M is arrested. This reduces the noise generated when the window glass WG strikes the movable range end while stopping the window glass WG in a substantially frilly closed state in which the upper end of the window glass WG is located in the weather strip Da.

When the window glass WG is closing, a lock stop process may be performed if rotation of the motor M is arrested by the entrapment of foreign material after entering mask section A1 and before entering soft stop section A3. In this ease, the controller 5 performs an update determination of reference position Ps, which will be described below, based on detection that rotation of the motor M has been arrested (detection of lock current).

In a state where the window glass WG slides relative to the weather strip Da, squeaking noise is generated in the system of the power window device 1. In the above soft stop process, the driving of the motor M is stopped in the state where the window glass WG slides relative to the weather strip Da, that is, when a squeaking noise is generated in the system. Thus, squeaking noise in the system cancels out the noise (such as relay noise) generated when the driving of the motor M is stopped.

When the controller 5 has performed the soft stop process an N number of times (for example, 50 times) after updating reference position Ps, the controller 5 invalidates the soft stop process in the next closing action. In a state where the soft stop process is invalid, the lock stop process is performed when the closing window glass WG reaches the end of the movable range end or reaches the vicinity of the movable range end. In this case, the controller 5 performs the reference position Ps update determination, which will be described below, when detecting that rotation of the motor M has been arrested (detection of lock current). Upon the updating of reference position Ps, the controller 5 validates the soft stop process.

The reference position Ps update determination will now be described.

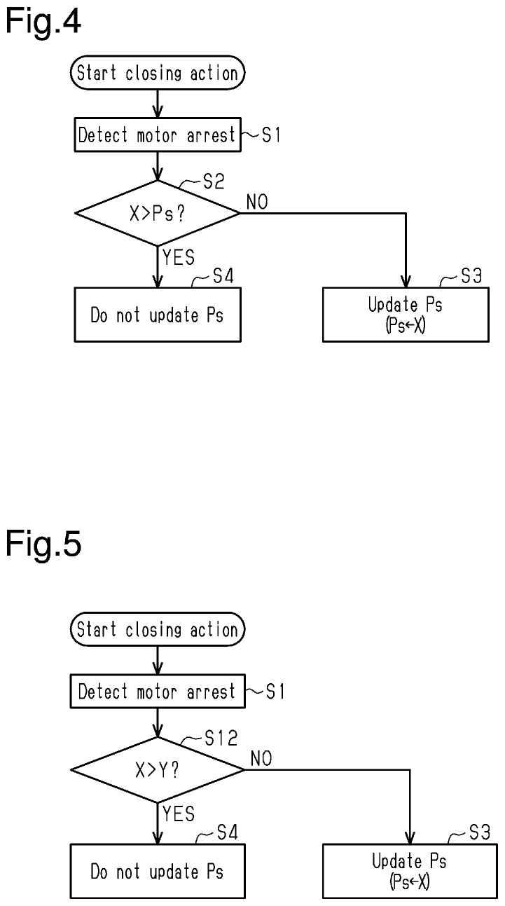

As shown in FIG. 4, when the controller 5 detects that rotation of the motor M has been arrested (lock current) in step S1, the controller 5 performs a reference position Ps update determination process in step S2. The reference position Ps update determination process determines whether arrest position X where the rotation of the motor M is arrested (position where lock current is detected) is located in the opening direction side of the currently recognized reference position Ps (i.e., X>Ps).

If arrested position X is determined as matching reference position Ps or as being located in the closing direction side of reference position Ps (i.e., X≤Ps) (step S2: NO), the process proceeds to step S3 and updates reference position Ps with arrested position X (Ps←X).

If arrested position X is determined as being located at the opening direction side of reference position Ps (step S2: YES), the process proceeds to step S4 and does not update reference position Ps.

The operation of the present embodiment will now be described.

When the window glass WG is closing, if foreign material is entrapped in mask section A1, the controller 5 performs the reference position Ps update determination when the entrapment arrests the motor M (detection of lock current). When entrapment occurs in mask section A1, arrested position X of the motor M is located toward the opening direction side of reference position Ps (X>Ps). Thus, the controller 5 determines not to update reference position Ps. Arrested position X resulting from the entrapment of foreign material is not overwritten as reference position Ps. Thus, reference position Ps and mask section A1, which is set based on reference position Ps, are not shifted toward the opening direction side from the desired position by the entrapment of foreign material.

The controller 5 in the present embodiment performs a soft stop process that stops supplying power to the motor M before rotation of the motor M is arrested (before lock current is detected) in soft stop section A3, which is proximate to reference position Ps. When the controller 5 has performed the soft stop process an N number of times after updating reference position Ps, the controller 5 invalidates the soft stop process in the next closing action. In other words, in a closing action in which the soft stop process is invalidated, arresting of the motor M can be detected, that is, reference position Ps can be updated. This sets a suitable reference position Ps in accordance with the aging deterioration or the like of the regulator R or the weather strip Da while also applying the soft stop process.

The advantages of the first embodiment will now be described.

(1) The controller 5 updates reference position Ps when arrested position X of the motor M is located toward the closing direction side of a set position (reference position Ps in the present embodiment), which is set in mask section A1. The controller 5 does not update reference position Ps when arrested position X is located toward the opening direction side of the set position (reference position Ps). Thus, when foreign material is entrapped in mask section A1, updating of the reference position Ps with the arrested position X of the motor M obtained during entrapment is limited. As a result, shifting of mask section A1 toward the opening direction side caused by entrapment of foreign material is limited. This limits increases in the distance from the lower end of the weather strip Da to the end of mask section A1 toward the opening direction side that would be caused by the updating of reference position Ps.

(2) The updating determination threshold value (set position) of reference position Ps is reference position Ps. In other words, reference position Ps is not updated if arrested position X of the motor M is located toward the opening direction side of reference position Ps. This further ensures that updating of reference position Ps is prevented when foreign material is entrapped in mask section A1. As a result, shifting of mask section A1 that would be caused by the entrapment of foreign material is prevented in a further ensured manner.

(3) The controller 5 performs a soft stop process that stops the supply of power to the motor M before rotation of the motor M is arrested during a closing action. When the controller 5 has performed the soft stop process an N number of times after updating reference position Ps, the controller 5 does not perform the soft stop process in the next closing action. With this configuration, the motor M is not arrested by the soft stop process unless foreign material is entrapped. Thus, reference position Ps is not updated until the soft stop process is performed an N number of times after updating reference position Ps. Thus, the controller 5, which performs such a process, determines whether to update reference position Ps as described above and further effectively limits shifting of reference position Ps and mask section A1.

The first embodiment may be modified as described below.

In the first embodiment, the threshold value (set position) for determining whether to update reference position Ps is reference position Ps. In other words, reference position Ps is not updated if arrested position X of the motor M is located toward the opening direction side of reference position Ps. However, there is no particular limitation to such a configuration.

For example, a threshold value (set position Y) for determining whether to update reference position Ps may be set as a position in the opening direction side of reference position Ps in mask section A1. The set position Y is set to a position spaced apart by a predetermined distance from reference position Ps, which is set as the reference.

In this case, as shown in FIG. 5, when the controller 5 detects that rotation of the motor M has been arrested (lock current) in step S1, the controller 5 determines in step 12 whether arrested position X where rotation of the motor M was arrested (position where lock current was detected) is located at the opening direction side of the presently recognized set position Y (i.e., X>Y).

When determined that arrested position X coincides with set position Y or that arrested position X is located toward the closing direction of set position. Y (i.e., X≤Y) (step S12: NO), the process proceeds to step S3 and updates reference position Ps with arrested position X. When determined that arrested position X is located at the opening direction side of set position Y (step S12: YES), the process proceeds to step S4 and does not update reference position Ps.

The operation of the present example will now be described.

Arrested position X of the motor M used to set (update) reference position Ps may be located at the opening direction side of reference position Ps depending on conditions such as the temperature or the battery voltage. Thus, by setting set position Y taking into consideration changes in arrested position X of the motor M caused by such an environmental factor, reference position Ps can be set (updated) in accordance with the present environmental condition. Further, when the motor M is arrested by entrapment of foreign material, control is executed so that reference position Ps is not updated.

Set position Y may be spaced apart by a certain interval from reference position Ps. The controller 5 may correct set position Y in accordance with the temperature or the battery voltage.

When determining whether to update reference position Ps in the first embodiment, if arrested position X of the motor M coincides with reference position Ps, reference position Ps is updated (Ps←X). However there is no particular limitation to such a configuration. That is, if arrested position X of the motor M coincides with reference position Ps, reference position Ps may or may not be updated because the same result will be obtained in either case.

In the first embodiment, arresting of the rotation of the motor M is detected from the lock current. Instead, arresting of the rotation of the motor M may be detected from the rotation speed of the motor M.

In the first embodiment, a soft stop process is performed based on changes in the rotation speed of the motor M. Instead, a soft stop process may be performed based on a motor current value.

The soft stop process performed by the controller 5 in the first embodiment is not essential. The present invention may be applied to a controller that does not perform a soft stop process.

In the first embodiment, the controller 5 is arranged integrally with the motor M and fixed to the vehicle door D. Instead, for example, the controller 5 may be separate from the motor M and located separated from the motor M to drive-control the motor M.

In the first embodiment, the present invention is embodied in the power window device 1 of a vehicle. Instead, the present invention may be applied to an opening-closing body drive device that drive-controls an opening-closing body other than a window glass WG (such as sunroof).

The above embodiment and modification described above may be combined where necessary.

A second embodiment of an opening-closing body drive device will now be described. Same reference numerals are given to those components that are the same as the corresponding components of the first embodiment.

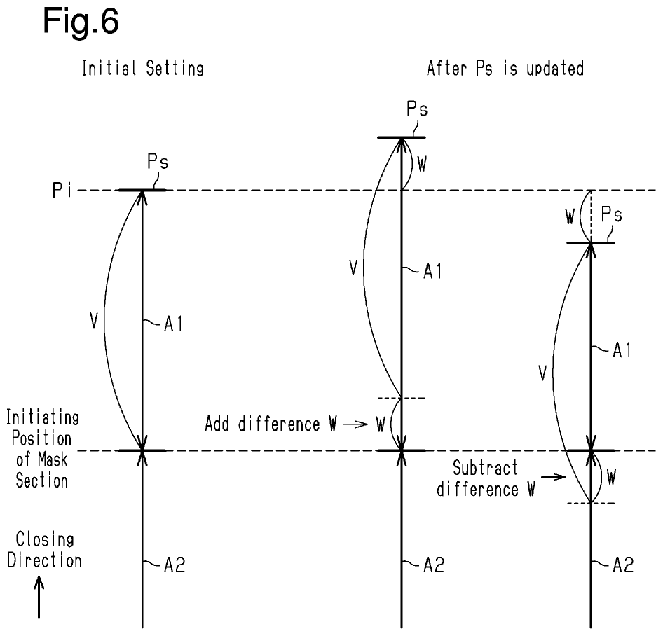

As shown in FIG. 6, the controller 5 closes the window glass WG when initial setting is performed during, for example, an assembling stage in a factory and stores an arrested position of the motor M during the closing action as an initial reference position Pi (reference position Ps in initial state). The controller 5 also sets the length of mask section A1 from initial reference position Pi to preset reference value V. Reference value V is preferably set such that the initiating position (lower end position) of mask section A1 is located about several millimeters lower than the lower end of the weather strip Da.

When the rotation of the motor M is arrested in the closing action after the initial setting, the controller 5 updates reference position Ps with the arrested position and calculates difference W of the arrested position (updated reference position Ps) and initial reference position Pi. The controller 5 corrects the length of mask section A1 to offset difference W. Specifically, if the arrested position (updated reference position Ps) of the motor M is located toward the closed direction side (upper side) of initial reference position Pi, the controller S adds difference W of the arrested position and initial reference position Pi of the motor M to reference value V. In contrast, if the arrested position (updated reference position Ps) of the motor M is located toward the open direction side (lower side) of initial reference position Pi, the controller 5 subtracts difference W of the arrested position and initial reference position Pi of the motor M from reference value V.

The operation of the second embodiment will now he described.

Aging changes of the weather strip Da raises the close end position of the window glass WG (i.e., arrested position of motor M) when a soft stop process is invalidated. In this case, the controller 5 updates reference position Ps with the arrested position of the motor M and adds difference W of the arrested position (updated reference position Ps) and initial reference position Pi to reference value V. This prevents changes in the initiating position (lower end position) of mask section A1 from the initial setting even if reference position Ps is updated upward.

Further, when the window glass WG is closing in a state in which the soft stop process is invalidated, arresting of the motor M may occur if foreign material is entrapped after entering mask section A1 and before entering soft stop section A3. If foreign material is entrapped in this section, reference position Ps is updated with the arrested position of the motor M caused by the entrapment so that updated reference position Ps is shifted downward from the desired position. In this ease, the controller 5 subtracts difference W of updated reference position Ps and initial reference position Pi from reference value V. Thus, the initiating position (lower end position) of mask section A1 does not change from that of the initial setting even if reference position Ps is updated downward.

The above correction process keeps the initiating position of mask section A1 fixed to that of the initial setting even if reference position Ps changes. Thus, the initiating position of mask section A1 is maintained and located about several millimeters lower than the lower end of the weather strip Da even if reference position Ps changes.

The controller 5 in the present embodiment performs a soft stop process that stops the supply of power to the motor M before rotation of the motor M is arrested (before lock current is detected) in soft stop section A3 that is proximate to reference position Ps. When the controller 5 has performed the soft stop process an N number of times after updating reference position Ps, the controller 5 invalidates the soft stop process in the next closing action. In other words, in a closing action in which the soft stop process is invalidated, arresting of the motor M can be detected, that is, reference position Ps can be updated. This sets a suitable reference position Ps in accordance with the aging deterioration or the like of the regulator R while also applying the soft stop process.

The advantages of the second embodiment will now be described.

(4) When rotation of the motor M is arrested in a closing action after the initial setting, the controller 5 updates reference position Ps with the arrested position and corrects the length of mask section A1 to offset difference W of the arrested position and initial reference position Pi (reference position Ps in initial setting). This maintains a constant initiating position of mask section A1 relative to the weather strip Da regardless of changes in reference position Ps. As a result, shifting of mask section A1 relative to the weather strip Da is limited.

(5) The controller 5 performs a soft stop process that stops the supply of power to the motor M before rotation of the motor M in a closing action is arrested. When the controller 5 has performed the soft stop process an N number of times after updating reference position Ps, the controller 5 does not perform the soft stop process in the next closing action. With this structure, in a state where the soft stop process is validated, situations are limited in which the motor M is stopped based on detection of a lock current. Thus, reference position Ps is fixed for a certain extent of time (period during which soft stop process is performed an N number of times at maximum) after reference position Ps is updated. Thus, the controller 5, which performs such a process, performs the correction process of the length of mask section A1. This further effectively limits shifting of mask section A1.

Further, the soft stop process stops driving the motor M in a state in which the window glass WG slides relative to the weather strip Da, that is, when a squeaking noise is generated in the system. Thus, the squeaking noise in the system cancels out noise (such as relay noise) generated when driving of the motor M is stopped.

The second embodiment may be modified as described below.

In the power window device 1 according to the second embodiment, aging deterioration of a transmission member such as a regulator R or a gear (i.e., slack wire or loose gear) that drive connects the window glass WG to the motor M results in a tendency to reduce the amount of movement of the window glass WG relative to the amount of driving of the motor M. In other words, aging deterioration of the transmission member results in a difference of positional information recognized by the controller 5 based on a pulse signal from the rotation detection sensor 2 and the actual position of the window glass WG. This may shift mask section A1 relative to the weather strip Da. Thus, the controller 5 according to the second embodiment may additionally perform a process for correcting the length of mask section A1 based on driving history such as the accumulated number of times the motor M is driven or the accumulated amount the motor M is driven. This limits shifting of mask section A1 in a further preferable manner. Further, an external sensor (such as load sensor, position sensor, or camera) that can monitor the position of the window glass WG may be included in order to add a process for correcting the length of mask section A1 based on positional information on the window glass WG from the external sensor. This also limits shifting of mask section A1 in a further preferable manner,

In the second embodiment, arresting of rotation of the motor M is detected based on a lock current. Instead, arresting of rotation of the motor M may he detected based on the rotation speed of the motor M.

In the second embodiment, the controller 5 is arranged together with the motor M and secured to the vehicle door D. Instead, the controller 5 may be separate from the motor M and located separately from the motor M to drive-control the motor M.

In the second embodiment, the present invention is embodied in the power window device 1 of a vehicle. Instead, the present invention may be applied to an opening-closing body drive device that controls driving of an opening-closing body other than a window glass WG (such as sunroof).

The embodiment and the modification described above may be combined where necessary.

1. An opening-closing body drive device comprising:
a motor that opens and closes an opening-closing body; and
a controller that controls driving of the motor, wherein
the controller recognizes an arrested position of the motor during a dosing action as a reference position and performs an entrapment process in a section excluding a mask section from the reference position to a predetermined position toward an opening direction side, and
the controller updates the reference position when the arrested position of the motor is located toward a closing direction side of a set position, which is set in the mask section, and does not update the reference position when the arrested position of the motor is located toward an opening direction side of the set position.

2. The opening-closing body drive device according to claim 1, wherein the set position is set toward the opening direction side of the reference position.

3. The opening-closing body drive device according to claim 1, wherein the set position is set at a position that is the same as the reference position.

4. The opening-closing body drive device according to claim 1, wherein
the controller performs a soft stop process that stops supplying power to the motor before rotation of the motor is arrested during the closing action, and
when having performed the soft stop process an N number of times after updating the reference position, the controller does not perform the soft stop process in a next closing action.

5. An opening-closing body drive device comprising:
a motor that opens and closes an opening-closing body; and
a controller that controls driving of the motor, wherein
when rotation of the motor is arrested during a closing action, the controller recognizes an arrested position as a reference position and performs an entrapment detection process in a section excluding a mask section having a predetermined length from the reference position toward an opening direction side,
the controller stores an initial reference position that is the reference position in initial setting, and
when rotation of the motor is arrested during a closing action, the controller corrects the length of the mask section to offset a difference of the arrested position and the initial reference position.

6. The opening-dosing body drive device according to claim 5, wherein
the controller performs a soft stop process that stops supplying power to the motor before rotation of the motor is arrested during a closing action, and
when having performed the soft stop process an N number of times after updating the reference position, the controller does not perform the soft stop process in a next closing action.
